(19) United States
(12) Patent Application Publication
(10) Pub. No.: US 2013/0226723 A1
(43) Pub. Date: Aug. 29, 2013

(54) Online System and Method for Facilitating Networking Between Buyers and Sellers Within a Specific Industry

(71) Applicants: Jeremy Chapman, Houston, TX (US); Adam Richard, Houston, TX (US)

(72) Inventors: Jeremy Chapman, Houston, TX (US); Adam Richard, Houston, TX (US)

(73) Assignee: Jeremy Chapman, Houston, TX (US)

(21) Appl. No.: 13/472,220

(22) Filed: May 15, 2012

Related U.S. Application Data
(60) Provisional application No. 61/602,965, filed on Feb. 24, 2012.

(51) Int. Cl. G06Q 30/00

(52) U.S. Cl. 705/26.2

(57) ABSTRACT

A system and method utilizing an online communications network and hardware connecting users in a specific industry with each other for the purposes of facilitating an efficient identification and exchange of relevant goods and services. Industry specific search tools are provided to allow users to quickly delimit an inventory of products and services, thus efficiently locating what they seek. The inventory of products and services is provided by other users who provide the necessary criteria so that search tools can be effective. Additional functionality allows a user to contact another user to request additional information and initiate negotiations wherein a successful transaction may occur either on site or off site.

### CROSS-REFERENCE TO RELATED APPLICATION(S)

The present invention claims the benefits of the filing date of U.S. Provisional Patent Application Ser. No. 61602965, filed on Feb. 24, 2012, the disclosure of which is hereby incorporated by reference in its entirety.

### FIELD OF THE INVENTION

The present invention relates generally to a system and method for facilitating the meetings between buyers seeking a certain goods and services, and sellers of said goods and services. More specifically, the present invention relates to a method of providing users with a way to identify interested buyers and sellers of various types of metal goods and related services based on various criteria.

### BACKGROUND OF THE INVENTION

A need exists for sellers of goods in the various specialty industries to efficiently provide an inventory of their goods to interested sellers.

A need exists for buyers of goods in the various specialty industries to efficiently identify a specific type of good from inventories of various sellers, and to identify the most relevant seller based on various criteria.

A need exists for buyers of metal to be able to efficiently locate a suitable source of a particular metal, based on such attributes as shape of the metal, type of metal, and the cost.

Various websites exist that allow an exchange of information between users. Social networks such as Facebook® and Myspace® allow for users to interact in a myriad of ways by allowing users to update their page with their status or current mood, upload pictures and videos, or write journals. Other uses can be allowed to comment or respond to that users update. Users can also create various groups to facilitate the exchange of information for a specific topic. Registered users of such websites can share information with each other within those groups based on a common interest.

One popular interest relates to the buying and selling of goods and services. Sites like eBay® and Craigslist® allow buyers and sellers to meet and transact business for goods and services. eBay® users create accounts, then can either proceed to list items for sale, or seek items they want by searching within the site. Searches can be narrowed within descriptive categories. Once a particular item is found, a buyer can then bid on the item within a time period. The winning bidder obtains the item. eBay® allows for the entire buying transaction to be completed through a coordination of messages, emails and payment services. Users can then provide feedback on each other that is viewable by other users. In this system, users are not completely anonymous.

Craigslist® allows users to also post about goods and services they have for sale or barter, or to also post requests or “want ads” for the same. Users are anonymous. The site provides for geographic limits on the various searchable categories, such as goods and services related to housing, the community or more generally, “for sale.”A user can search for the specific item by identifying it as specifically as possible and then combing through the various results until the desired item is found. The user can then contact the seller and at that point, all further transactions occur independently of Craigslist®.

Despite the existence of such websites, there still exists a need for buyers and sellers in a specific industry to be able to identify each other with respect to various goods and services related to that industry. There needs to be an online system that allows a user to provide information about the goods and services that they provide that can be neatly sorted into various categories, allowing other users to be able to provide specific criteria in those categories, thus identifying a specific good or service they seek. This need is especially great in the metals industry where buyers of particular metals have a need to be able to identify sources that can provide them with the particular metal at the best price.

Another need is to be able to identify sellers within a specific geographical area so as to facilitate transport, saving both time and delivery costs. Yet another need is to identify services that can adapt or finish a particular metal to their specific need if no existing metal can be found.

### SUMMARY OF THE INVENTION

This section provides a general summary of the disclosure, and is not a comprehensive disclosure of its full scope or its entire feature.

In one embodiment, the system includes a computer program stored on a computer-readable storage medium and implemented on hardware. The program consists of a collection of various modules linked together, allowing for the exchange of data. These modules consist of programming sub-routines that perform specific tasks.

The system allows for hosting an industrial metals exchange module allowing industrial metals, as raw materials of various grades, conditions, and standards to be listed, searched, bought, and sold through the use of various modules.

Other modules include conversion and pricing calculators and a variety of metal industry newsfeeds.

It is an object of the invention that each user has complete autonomy in the process of procurement, sourcing, negotiation, managing inventory, request for quotation outsourcing (request for quotation services allows a buyer to outsource their respective procurement list of items. The service provided offers the sourcing of products while taking into consideration all aspects and attributes), accessing resources to industry knowledge, complex metal calculation tools, personal profile tools, locating metal service/processing centers such as drilling, heat treating, grinding, manufacturing, fabricating, threading, transporting, honing, and other processing known to one in the art, as well as sharing and promotion of inventory item information, and a support portal.

It is an object of the invention to provide a library of knowledge and resources that can be easily referenced, which enables users to make informed decisions. This library consists of information needed to have a thorough understanding of the industrial metals industry. Users will also be able to contribute relevant information to the community library.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1 depicts buyers and sellers connected to each other on a server through a network. Buyers and sellers can use a variety of known clients that reside on computers, tablet computers and handheld computing devices.

FIG. 2 depicts one of two possible interfaces a user could access. A user with administrator level permission will access an interface with back-end capabilities, while the typical user will access an interface with front-end capabilities. The server includes a database capable of storing information for retrieval. The server also includes one of more processing modules dedicated to specific tasks.

FIG. 3 depicts the processing module which includes several modules, such as modules dedicated to interface, calculations, transactions, store locators, negotiation, ratings feedback, information handling and overall management of the site.

FIG. 4 shows a flow chart of an interface for a user acting as a buyer of metal goods and services.

FIG. 5 shows a flow chart of an interface for a user acting as a seller of metal goods and services.

FIGS. 6a and 6b shows an interface for conducting a search for metal by a buyer. FIG. 6a shows a broad search setting, while FIG. 6b shows a narrower search setting.

FIG. 7 shows an interface for listing metal service companies by service, location, and by proximity to a designated point.

FIG. 8 shows an interface for seller listing, including the ability to list items by line entry, or by filing in a spreadsheet template provided by the site.

FIG. 9 depicts other modules that provide additional functionality to the site.

FIG. 10 depicts a conversion calculator for converting units of hardness, pressure, temperature, length weight, volume and other relevant measurements.

FIG. 11 depicts an interface to locate service centers.

FIG. 12 depicts a calculator for determining weight, size, cost, as well as cost for various treatments based on the size of the metal.

FIG. 13 depicts an interface for a messaging module that allows a user to contact a seller regarding an item they have listed.

FIG. 14 depicts a module that enables the buyer to save a metal product defined according to various search criteria to a folder for later retrieval.

FIG. 15 depicts a module that enables the buyer to outsource their respective procurement list of items.

### DETAILED DESCRIPTION OF THE EMBODIMENTS

Before explaining the present apparatus in detail, it is to be understood that the system and method is not limited to the particular embodiments and that it can be practiced or carried out in various ways.

In one embodiment of the invention for use in the metals industry, the system allows users to access a website using devices such as computers, tablet computers, smartphones and handheld computing devices capable of accessing the World-Wide Web, wherein the users can offer goods and services for sale or locate desired goods and services for a particular industry, such as the metal industry. The search module allows users to search for the good or service they seek using various criteria. Availability of that good or service is determined by other users indicating that they have such goods in inventory for sale, or can provide that service. The system also provides tools to assist a user. The system provides various calculation modules. One calculation module calculates dimensions such as individual weight of an item using other information such as the size and type of metal, or a total weight of several pieces of the same item. A user can also calculate the total cost of an order of multiple items. A user can also calculate various measurements, such as inner diameter and wall thickness of metal tubes.

The calculator can also be used to determine the cost associated with various treatments and processes known in the metal industry for various sizes and types of metals.

Another calculation module allows a user to make mathematical conversions for various measurements and calculations relevant to that industry, such as pressure, hardness, temperature and length.

The system also includes an information or library module where users can learn about basics of the industry. For example, in the industrial metals industry, the library would assist buyers in making informed decisions by allowing them quick access to an information database to better understand the qualities and properties of a certain type of metal. Users would also be able to contribute information to the database.

The system would include a newsfeed module, capable of aggregating industry-relevant newsfeeds that would be of interest to a user. In another embodiment, a user could personalize this newsfeed to fit their specific role in the industry. For example, in the industrial metals industries, the selected newsfeeds could include newsfeeds related to buyers and sellers in the metals industry.

The system would include a service/processing locator module that would permit a user to identify a specific service or process, and then determine where such a provider of a service or process is located.

The present embodiment for the method of buying and selling in the industrial metal industry could include the steps of:

1 A user accessing the website using a client capable of accessing the World-Wide Web through a network. The user can either be a seller, a buyer or an administrator.

2 After securely logging in, if the user is seeking to procure metal products or services, e.g., a buyer, the user can either begin a search for a specific metal by adjusting, selecting and/or identifying specific attributes. Alternatively, the user may procure metal items by uploading a list of what they require and allowing the site to locate the items requested by searching the available seller inventory. Alternatively, if the user regularly seeks a specific metal, and has saved the profile of that metal in the account folder, the user may recall that specific metal profile and search in that manner. A user may also refer to previous search history. Once the search is initiated, results are returned to the user. In the case of a user seeking to sell their metal, the seller, after logging in, can proceed with listing their metal, either by using the site's interface to list their metal by line entry, or by using a form provided by the site to “batch import” a list of metals. The identities of the sellers of the resulting metal products are not provided.

3 After reviewing the results, the user can then anonymously or non-anonymously contact any of anonymous sellers of the metal. The buyer can send a message to a seller, which will then go to the seller's site inbox, and if the seller has permitted, a copy of the message can also be sent to the seller's email address. The seller can check their site inbox or their email inbox to see if they have been contacted by any interested buyer. The seller can then choose to contact the interested buyer and begin negotiations.

4 Once contacted, if the seller responds, negotiation can take place between the buyer and seller.

5 If negotiation is successful, the buyer and seller can then independently complete the transaction either independently, or through a transaction module provided by the site.

If the user is an administrator, the administrator has access to a different interface which allows for back-end maintenance of the site.

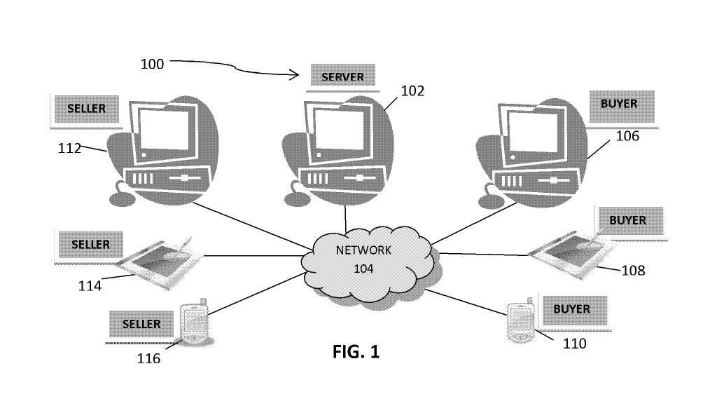

FIG. 1 shows a server 102 communicably connected through a network 104 to buyers 106, 108 and 110, and sellers 112, 114, and 116, on examples of various hardware capable of accessing the network 104. The computer program can be implemented on the hardware server which includes a computer readable storage medium and computer commands to allow interfacing with the network and the various client computers used by sellers and buyers.

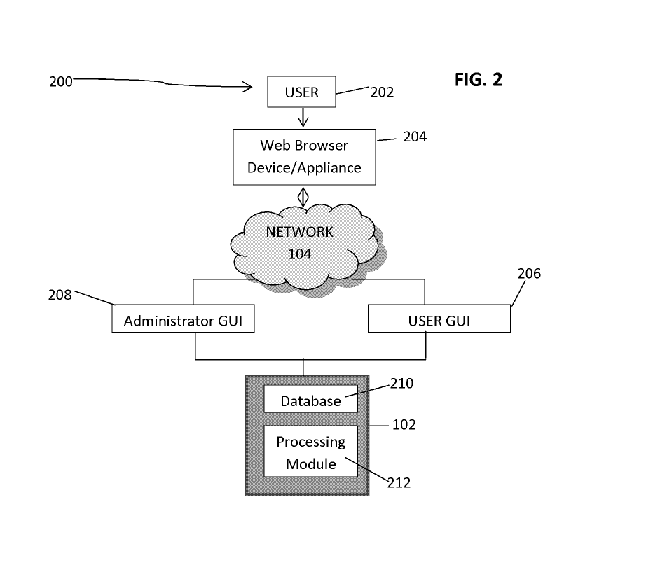

FIG. 2 shows a user 202 using a device containing a client capable of accessing the network 104, such as the World-Wide Web or a local area network, which is connected to the server 102. Separate interfaces 206 and 208 exist. A typical user will access interface 206, while an administrative user will have access to interface 208, in addition to interface 206. The server 102 can contain one or more databases 210 and one or more processing modules 212.

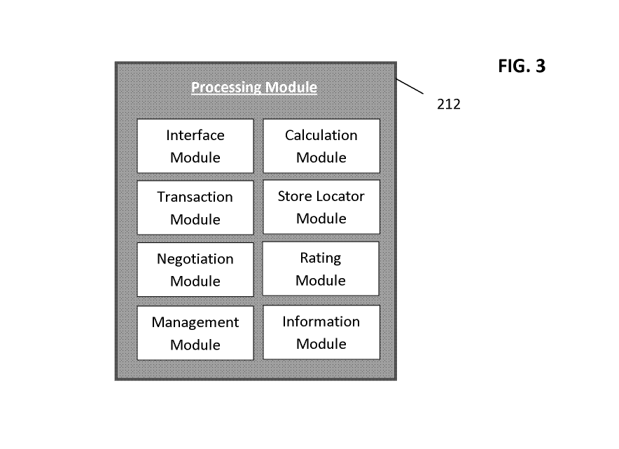

FIG. 3 shows a processing module 212 that can contain modules for user interfaces, calculation modules, transaction modules, store locator modules, negotiation modules, rating modules, management modules, information modules, and other modules that add functionality to the system. The modules carry out specific functions and allow for computer controlled commands to be sent and received over the network between the server and the client hardware operated by the users.

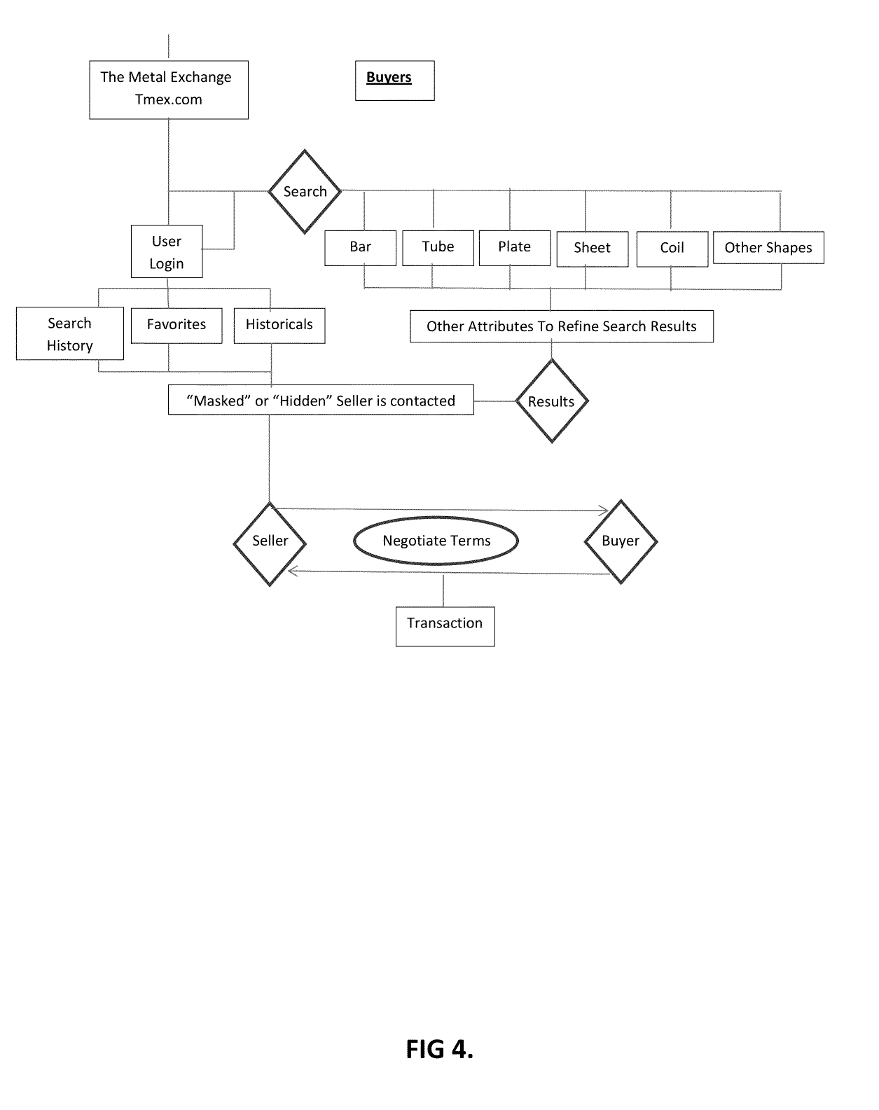

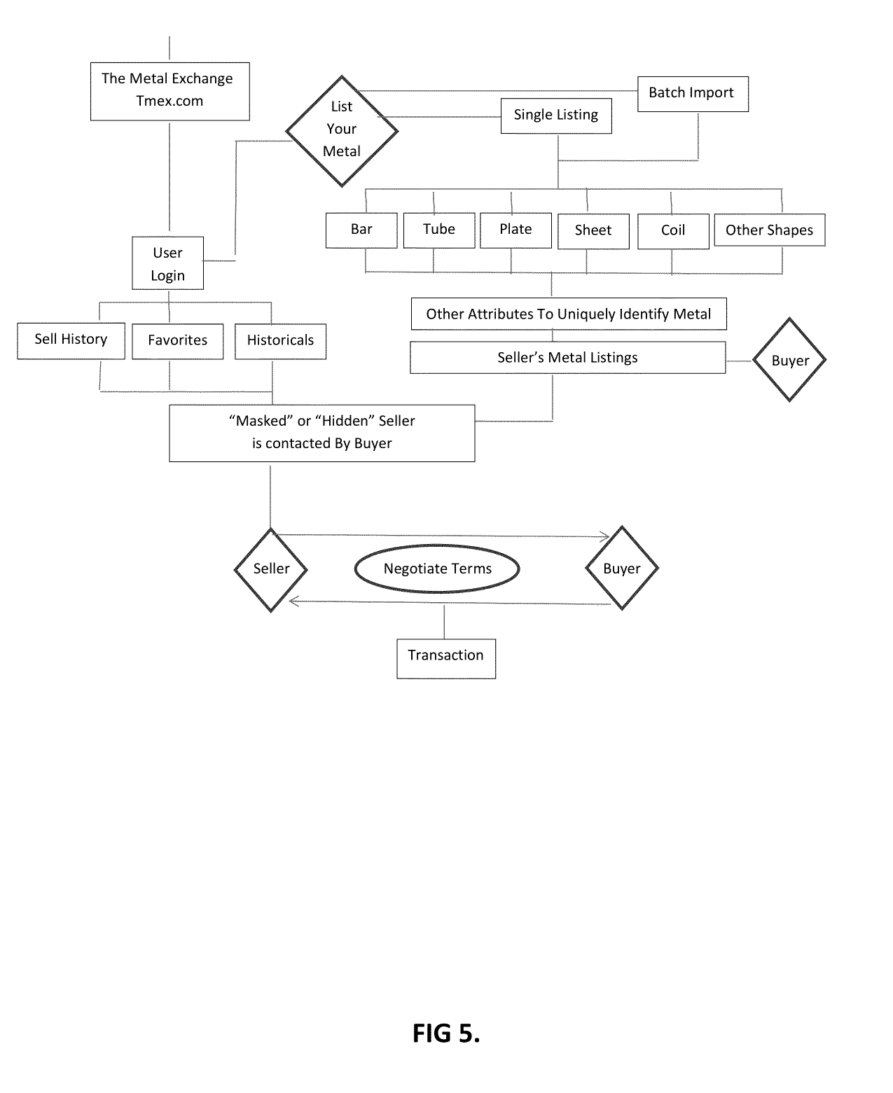

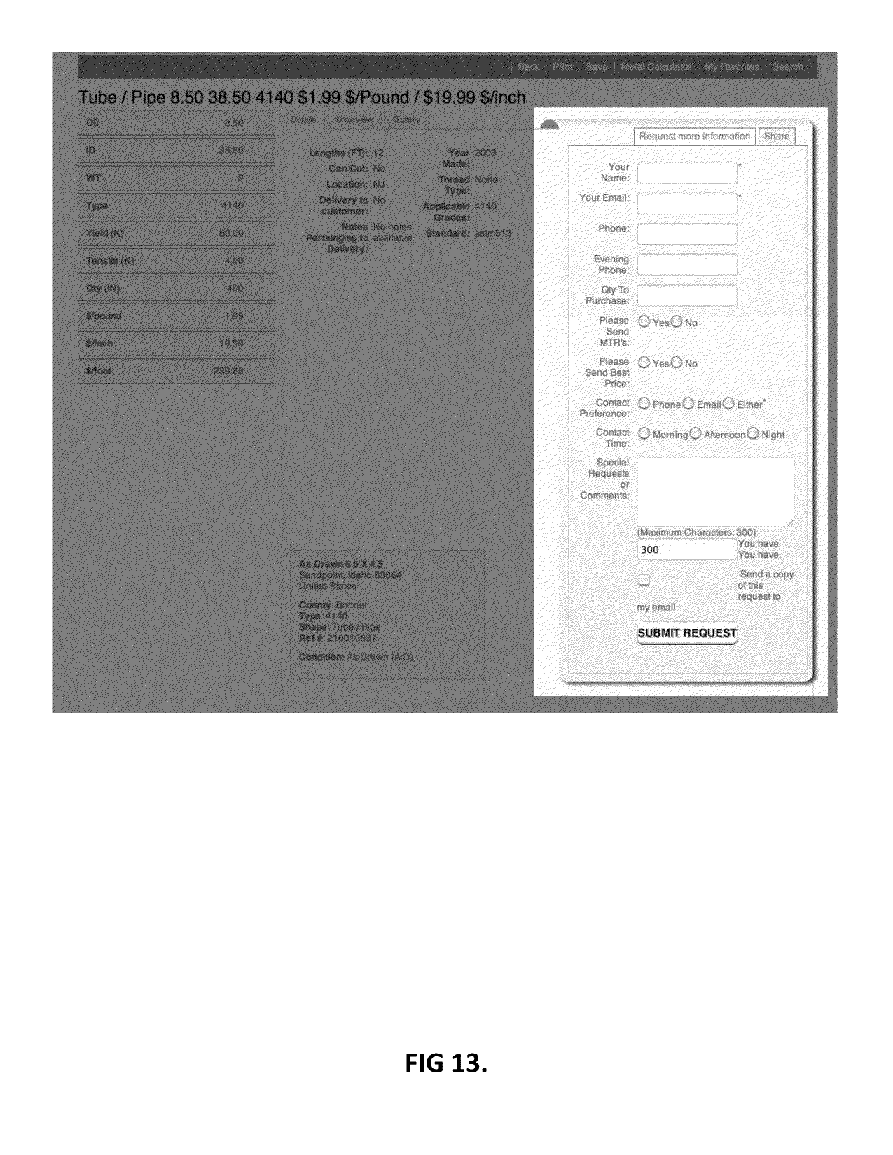

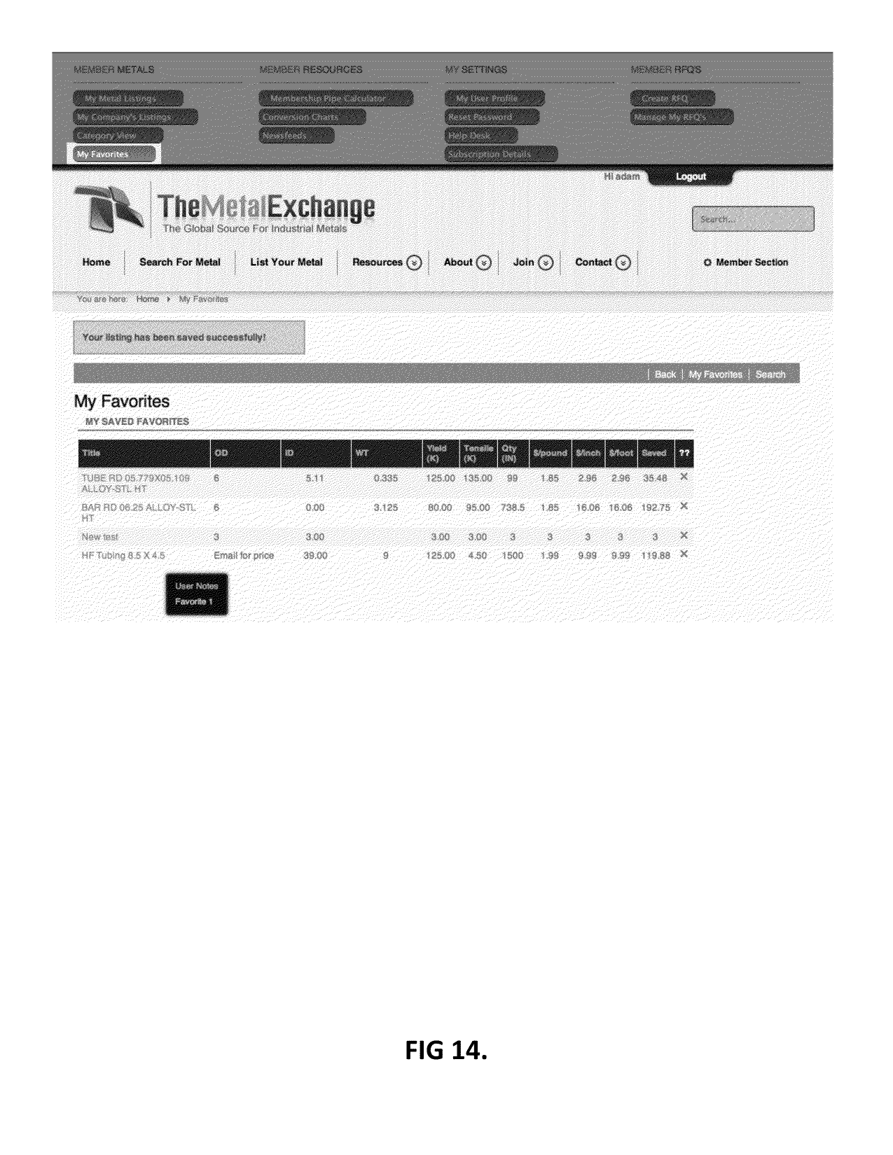

FIG. 4 shows a flowchart of a possible embodiment of an interface for a buyer. A buyer can locate a seller of a particular metal item by executing a search with defined criteria, or by accessing either previously defined metal profiles saved in a “favorites” folder as in FIG. 14, or by accessing past search history as in FIG. 16. Once the seller is contacted and chooses to respond to the buyer, negotiations can take place and upon successful negotiation, the transaction can be completed. Message sending and receiving can occur on the website through a messaging interface such as in FIG. 13. An interested buyer can request more information and using a form on the website, submit an information request to the seller.

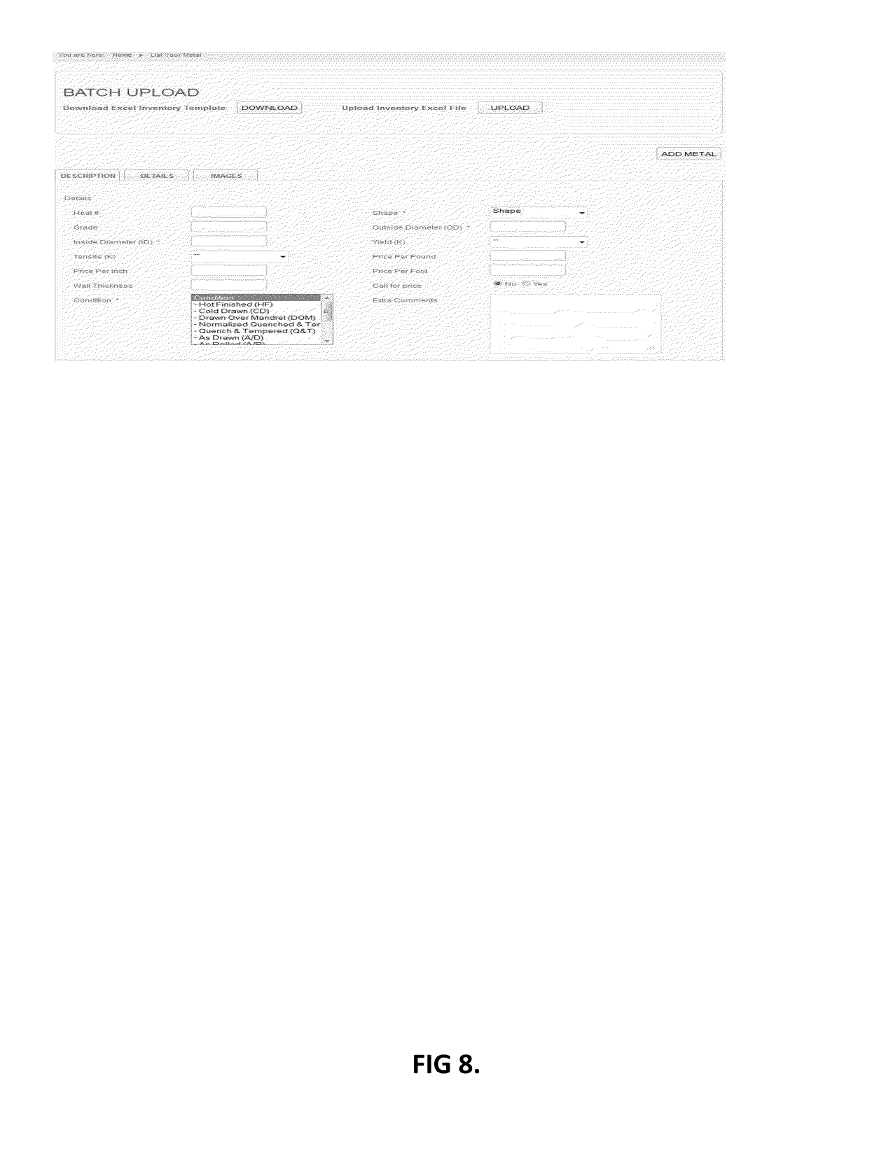

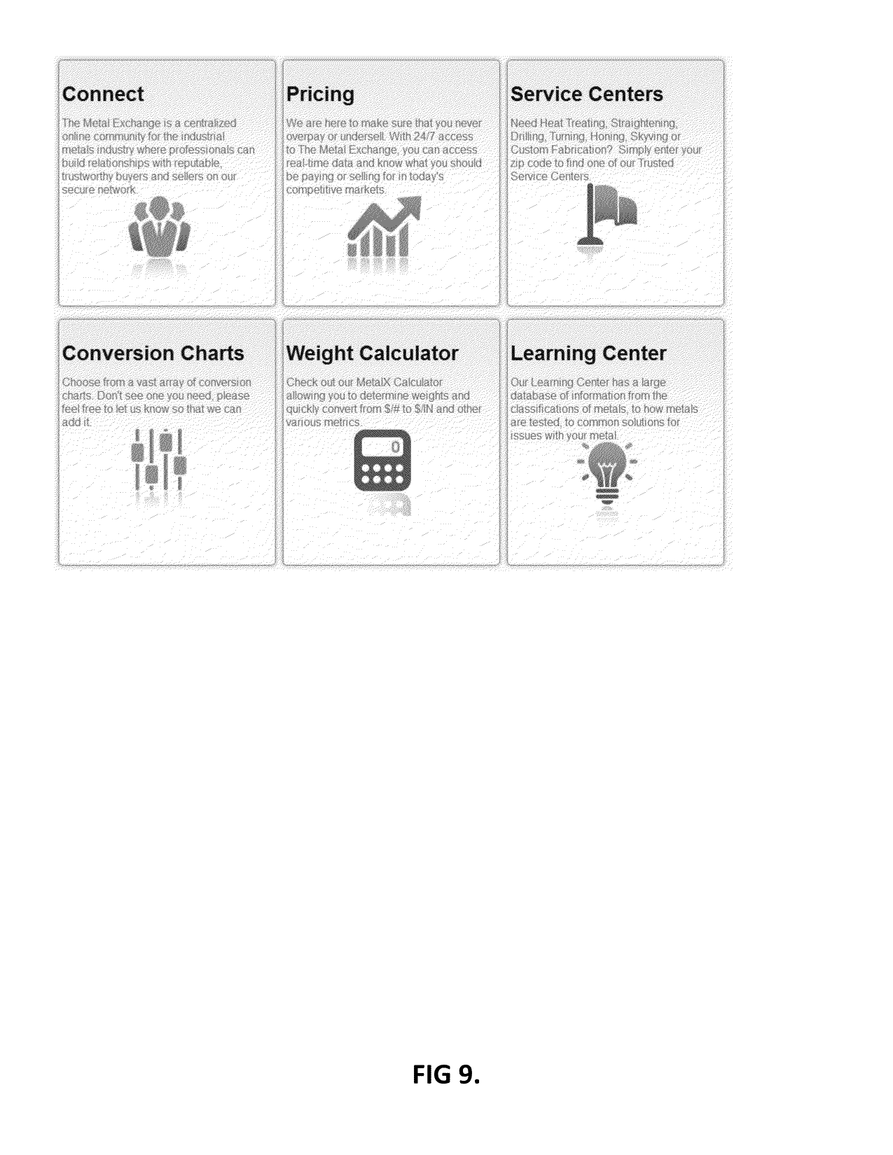

FIG. 5 shows a flowchart of a possible embodiment of an interface for a seller. After the user logs in, the seller can list metal for sale by either using a single listing interface wherein listing is done line by line, or by using a batch import feature which would allow the user to send a file containing a document listing more than one metal. The batch upload interface in FIG. 8 allows a user to use a pre-designed inventory template that permits a full inventory listing to be updated by a batch upload. Alternatively, the interface allows a user to update the database directly with a single metal item. If an interested buyer contacts the seller, the seller can opt to contact the buyer for negotiation and if successful, complete the sales transaction.

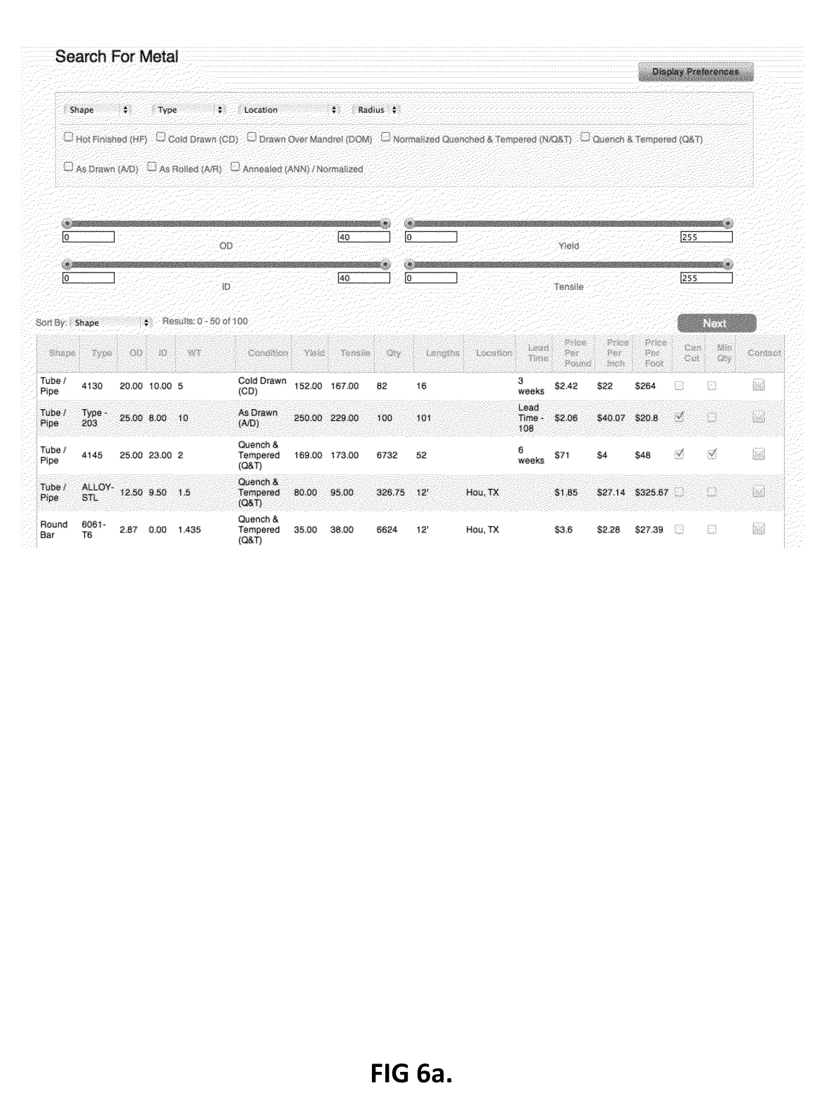

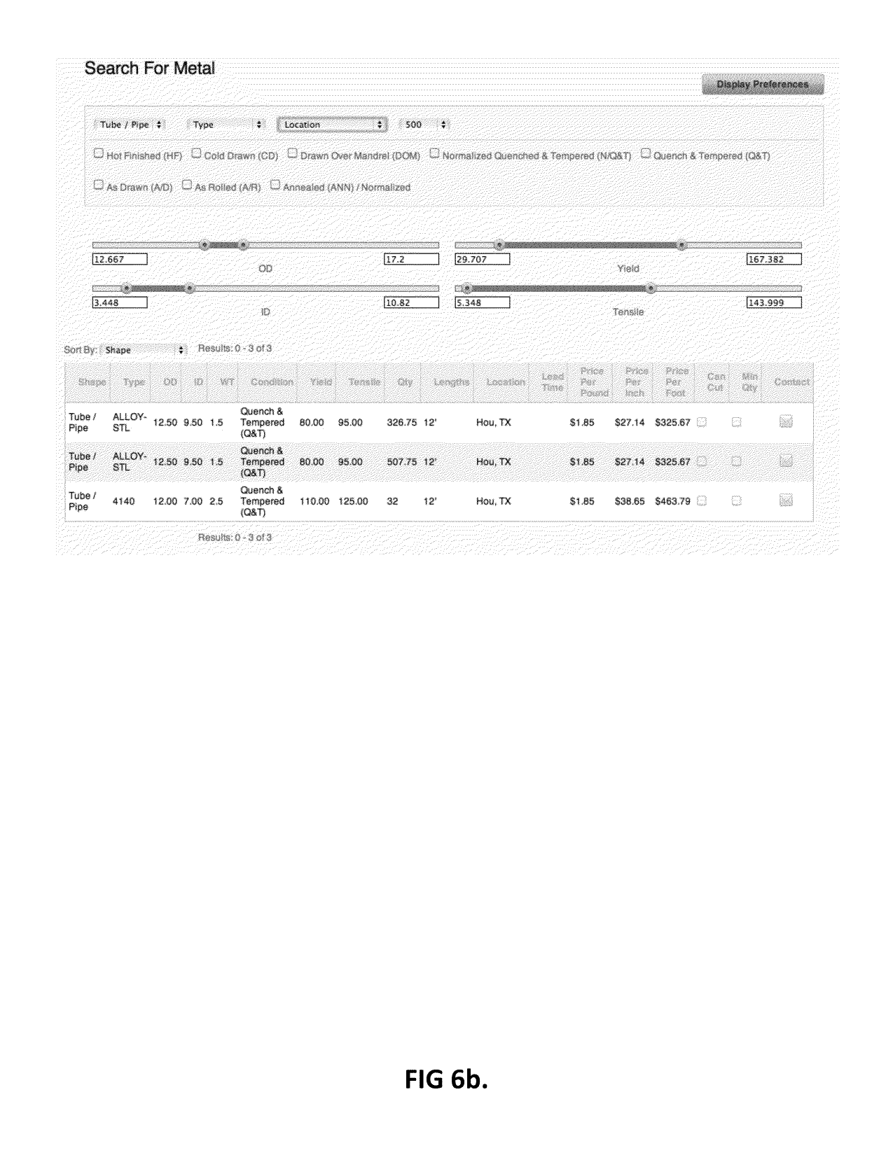

An embodiment of the search interface for a buyer seeking metal is shown in FIG. 6a and FIG. 6b. FIG. 6b depicts a search limited to provide a narrower scope of results. As the user inputs various criteria, the dynamic search allows the search results to be simultaneously displayed as the inputs are adjusted. The user can define the shape, type, location, geographical search radius, as well as other qualities specific to the metal industry, such as tensile strength. The display results are customizable to the user's preferences. By clicking on a result, a user can then contact the seller of that metal for more information.

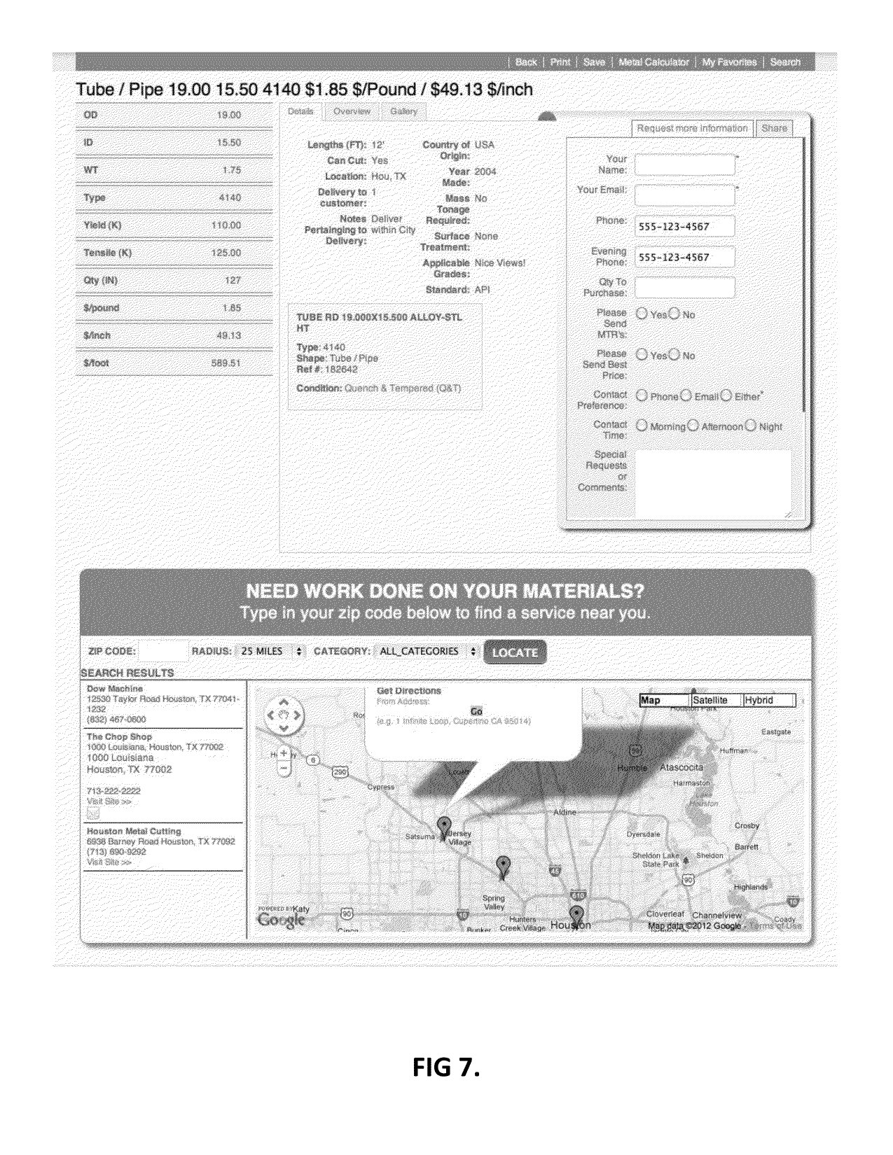

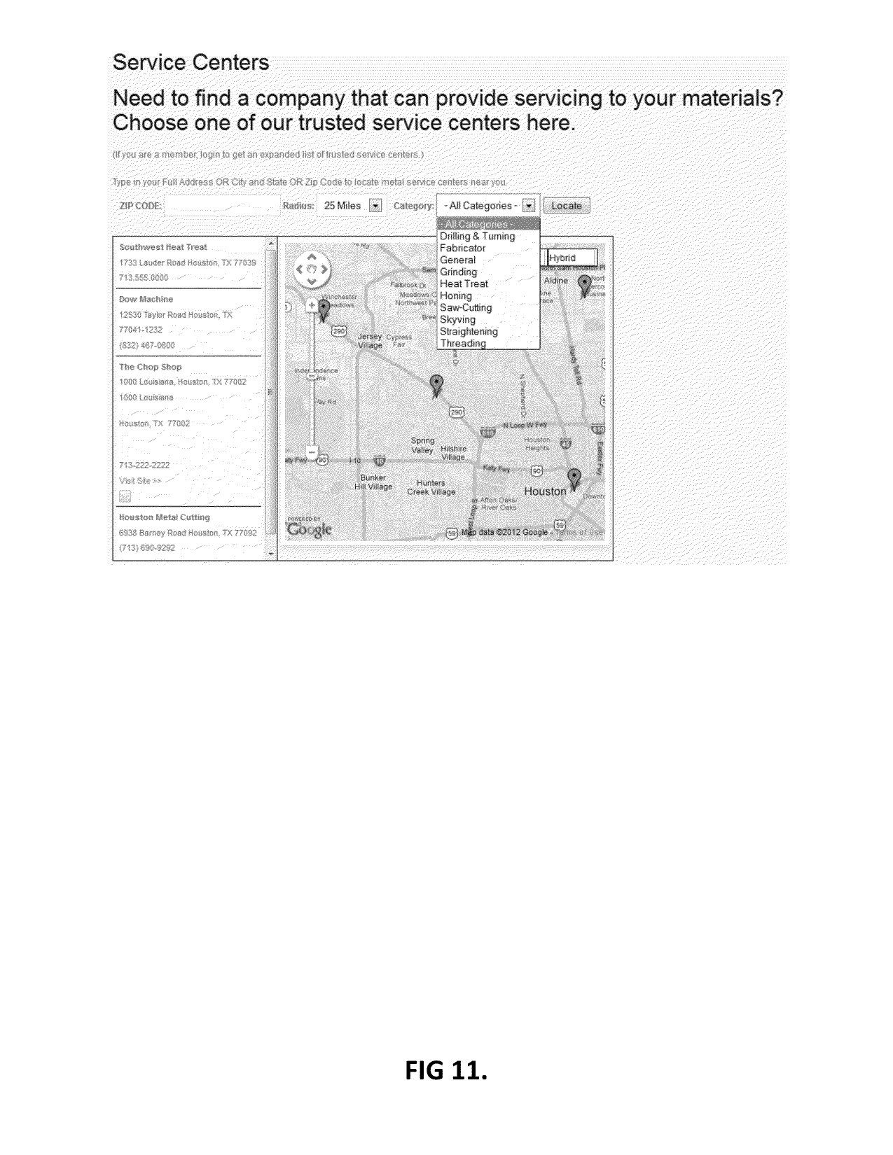

The metal service listing interface in FIG. 7 and FIG. 11 displays to a user the metal services available by location and within a certain geographical radius of that location. The user can narrow the type of services desired.

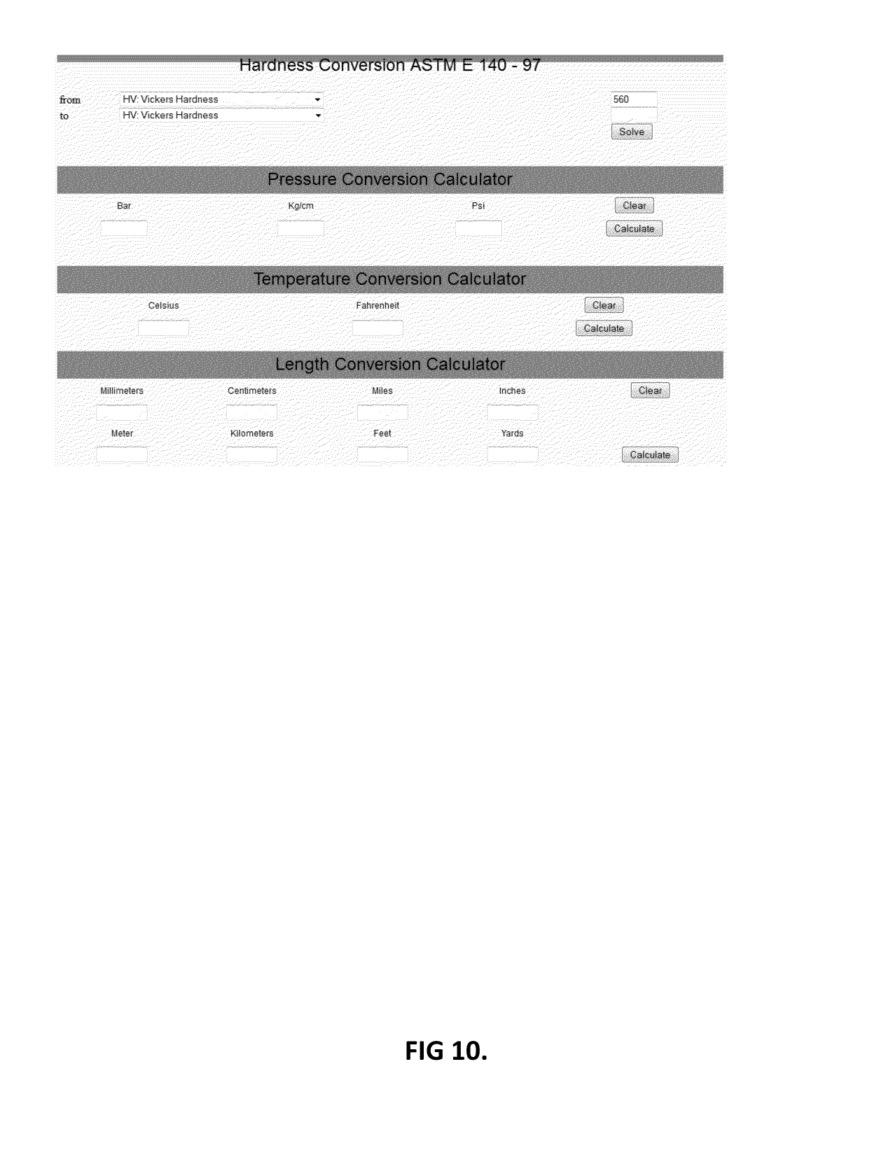

Other modules provide industry-specific tools to aid a user. The conversion center interface in FIG. 10 allows a user to make calculations to convert units of measurement between S.I. and metric systems. In this embodiment, the ability to convert units of pressure, temperature, length and hardness are provided, but can be expanded to include other measurements such as weight, volume, and density.

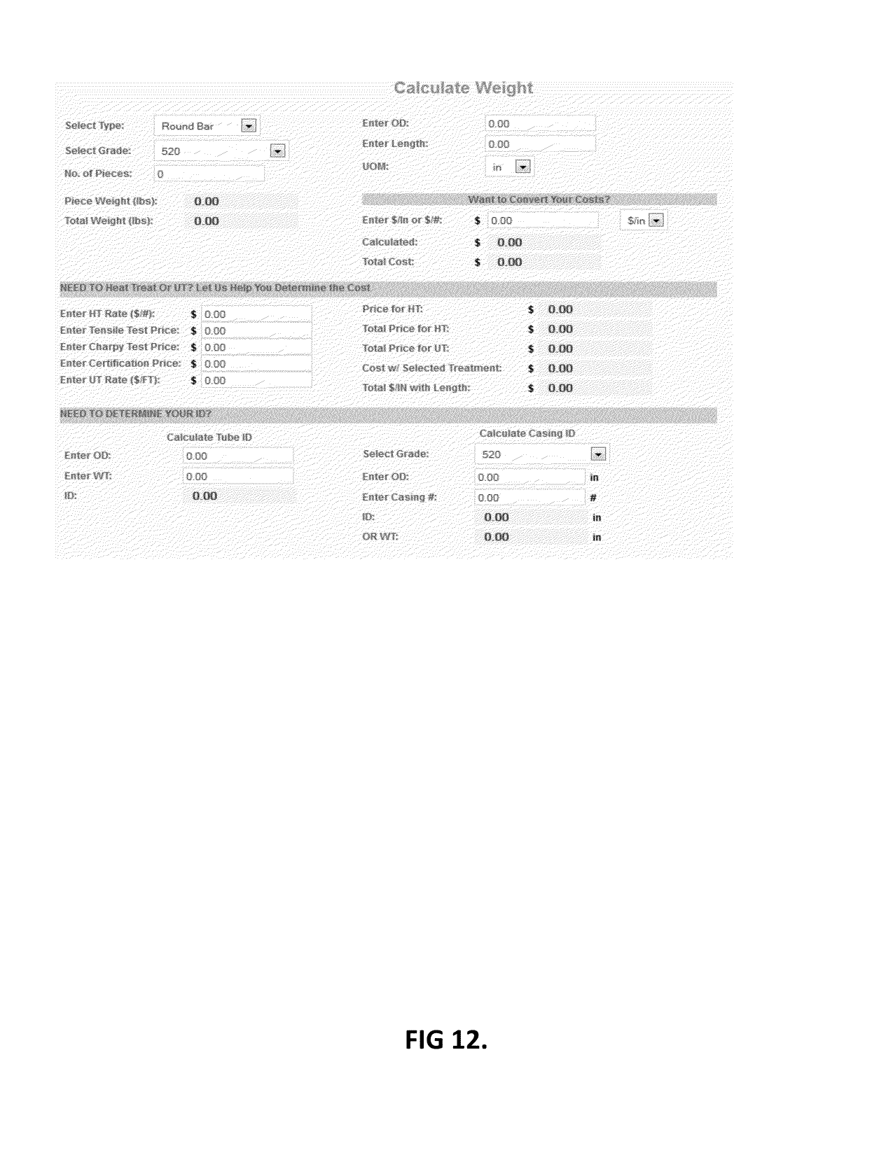

A calculator module interface as in FIG. 12 can be provided which allows a user to determine the total weight and cost of a proposed order of metal products, as well as the outer diameter, inner diameter and wall thickness of a metal tube. The total cost for processes and services for a metal item that are based on the size or volume of the item can also be calculated.

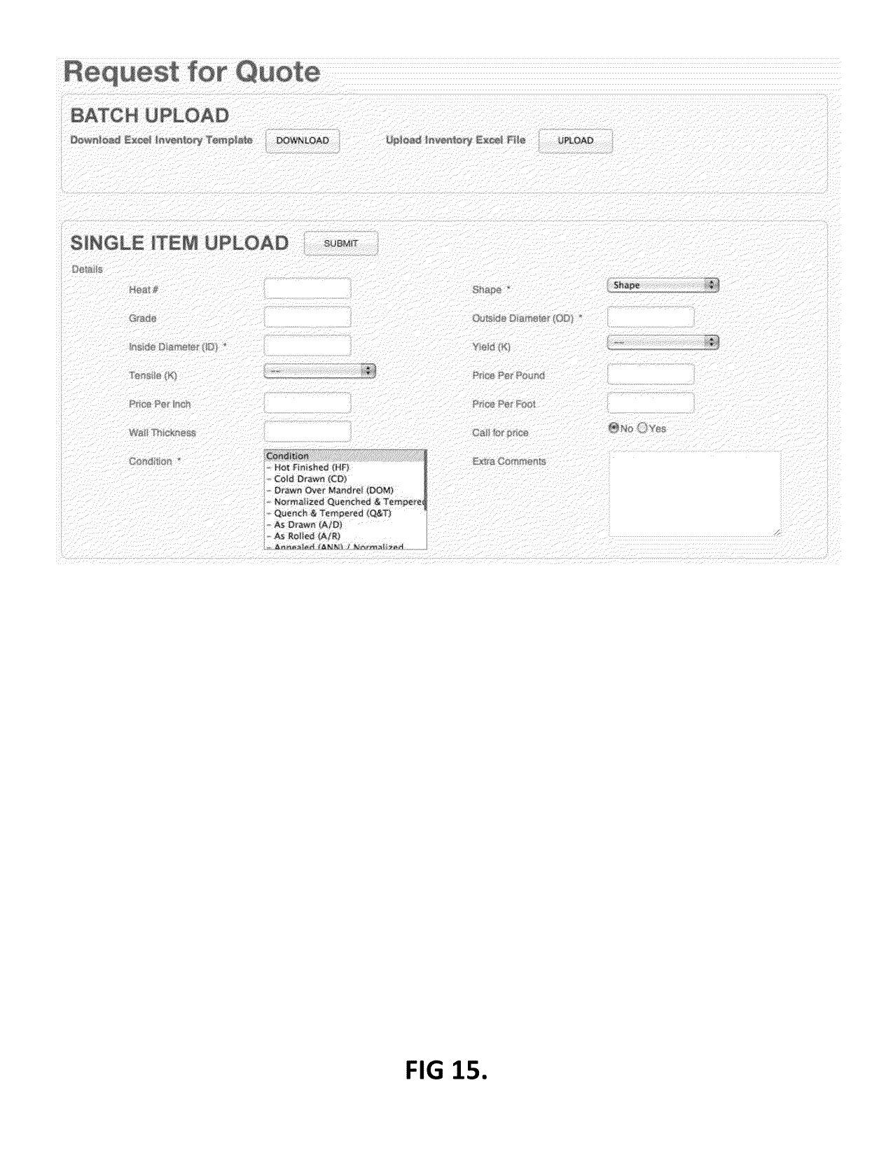

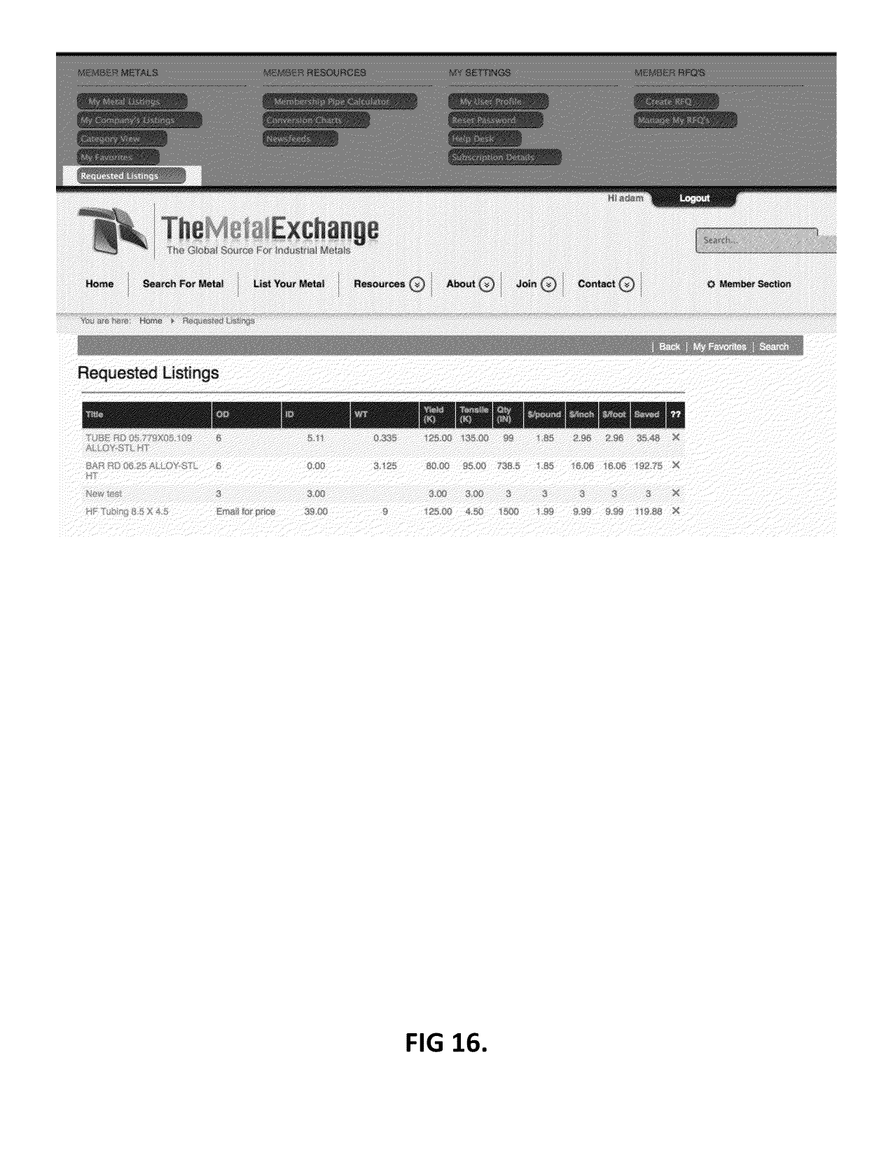

Another module as depicted in FIG. 15 would allow a user to provide a list of items that user wishes to locate and purchase. The module would then seek the items on the list according to the parameters that the user provides and indicate to the user how many of those items are available from the current seller inventory.

While these embodiments have been described with emphasis on the embodiments, it should be understood that these embodiments can be practiced other than as specifically described herein within the scope of the invention.

What is claimed is:

1. An interconnected computerized system providing real-time interaction between a plurality of users over a communications network, the system comprising:
A web server operably connected to a network capable of supporting communications, said web server comprising a database and one or more processor modules, said database accessible by one or more said consumer interfaces, administrator interfaces and service provide interfaces for communications there between;
A plurality of client subsystems connected to said server through said network, each client subsystem comprising at least one of each of a consumer interface, an administrator interface, and a service provider interface, wherein said interfaces comprise computer commands executable on client and server processors to allow the exchange of data between said interfaces;
A listing interface on said client subsystem for providing listings of items provided by users to be stored on said web server database;
A search interface on said client subsystem for locating items and services of interest stored on said web server database.

2. The system of claim 1, further comprising a communications interface to allow users to communicate with each other.

3. The system of claim 1, further comprising one or more calculation modules for performing mathematical functions.

4. The system of claim 2, further comprising a calculator module with conversion formulas for miscellaneous calculations.

5. The system of claim 2, further comprising a commerce module for users to transact the sale of metal products.

6. A system for establishing an online marketplace for buyers and sellers of metals and metal finishing services, the system comprising;
a server operably connected to a network;
a plurality of client devices operably connected to said network;
said client devices having an interface to interact with various modules related to the marketplace located on said server;
said server having a membership module for users accessing the system from a client device;
said server having a storage means to store information related to the marketplace;
said server having a listing module to organize, and display metal items provided by one or more users;
said server having a module to display providers of metal related services;
said server having a search module to locate specific metal items and services desired by one or more users.

7. A method of matching buyers of metals and metal services with sellers of metals and providers of metal services over a computerized network, the method comprising the steps of:
A user accessing an online server on a network through a user interface to create an account to be a registered seller or registered buyer;
Registered sellers storing a listing of their metal inventory onto one or more server storage databases;
Registered providers of metal services advertising their metal services;
Registered buyers searching the listings stored on the database for specific metals or metal services; and
Registered buyers contacting the registered sellers of specific metals or registered providers of specific metals services for further information.
